(19) United States
(12) Patent Application Publication
(10) Pub. No.: US 2022/0005141 A1
(43) Pub. Date: Jan. 6, 2022

(54) VEHICLE MANAGEMENT DEVICE, VEHICLE MANAGEMENT METHOD, AND VEHICLE

(71) Applicant: PANASONIC INTELLECTUAL PROPERTY MANAGEMENT CO., LTD., Osaka (JP)

(72) Inventor: Hayashi ITO, Kanagawa (JP)

(73) Assignee: PANASONIC INTELLECTUAL PROPERTY MANAGEMENT CO., LTD., Osaka (JP)

(21) Appl. No.: 17/480,437

(22) Filed: Sep. 21, 2021

Related U.S. Application Data
(63) Continuation of application No. PCT/JP2020/013176, filed on Mar. 24, 2020.

(30) Foreign Application Priority Data
Mar. 29, 2019 (JP) 2019-068807

(51) Int. Cl. G06Q 50/30; G06Q 30/06; B60R 25/24; B60R 25/01

(52) U.S. Cl. CPC G06Q 50/30; B60R 25/01; B60R 25/24; G06Q 30/0645

(57) ABSTRACT

A vehicle management device includes: a communication device configured to communicate with a rental vehicle owned or managed by an owner member and a renter member vehicle owned or managed by a renter member; a processor; and a memory having instructions. The instructions, when executed by the processor, cause the vehicle management device to perform operations including: checking a state of the renter member vehicle in response to receipt of an unlocking request notification from the rental vehicle; determining that an unlocking condition is satisfied in a case where the renter member vehicle is under management of a vehicle management system; and transmitting unlocking permission information for unlocking an electronic lock of the rental vehicle through the communication device in a case where the unlocking condition is determined to be satisfied.

### CROSS-REFERENCE TO RELATED APPLICATIONS

This application is a continuation of PCT International Patent Application No. PCT/JP2020/013176 filed on Mar. 24, 2020, which claims the benefit of priority of Japanese Patent Application No. 2019-068807 filed on Mar. 29, 2019, the entire contents of which are incorporated herein by reference.

### FIELD

The present disclosure relates to a vehicle management device, a vehicle management method, and a vehicle in a vehicle management system that manages a vehicle rental.

### BACKGROUND

As a system in which a vehicle is used by a plurality of users, there is a car sharing system. The car sharing system is a system in which a specific user who has registered as a member shares a vehicle. For example, JP-A-2010-272102 discloses a shared vehicle management system in which a plurality of vehicles dispatched at a parking lot are shared by a plurality of users specified by identification information. In the shared vehicle management system of the related art, a preferred one that best meets the user's needs can be selected after the user actually sees the vehicles, from the plurality of vehicles matching a selection condition of the user.

### SUMMARY

An object of the present disclosure is to provide a vehicle management device, a vehicle management method, and a vehicle that can realize further improvement in a case where a vehicle is rented between users of car sharing.

According to an aspect of the present disclosure, there is provided a vehicle management device in a vehicle management system configured to manage a vehicle rentable between users, the vehicle management device being configured to process member information on a user of the vehicle management system, member vehicle information on a vehicle owned or managed by the user, and reservation management information on reservation of use of the vehicle, the vehicle management device including: a communication device configured to communicate with a rental vehicle owned or managed by an owner member who desires to rent out a vehicle and a renter member vehicle owned or managed by a renter member who desires to rent a vehicle; a processor; and a memory having instructions that, when executed by the processor, cause the vehicle management device to perform operations including: checking a state of the renter member vehicle in response to receipt of an unlocking request notification from the rental vehicle through the communication device, the unlocking request notification indicating receipt of an unlocking request based on key information for allowing the renter member to temporarily use the rental vehicle; determining that an unlocking condition is satisfied in a case where the renter member vehicle is under management of the vehicle management system; and transmitting unlocking permission information for unlocking an electronic lock of the rental vehicle through the communication device in a case where the unlocking condition is determined to be satisfied.

According to another aspect of the present disclosure, there is provided a vehicle management method in a vehicle management device of a vehicle management system that manages a vehicle rentable between users, the vehicle management device is configured to: process member information on a user of the vehicle management system, member vehicle information on a vehicle owned or managed by the user, and reservation management information on reservation of use of the vehicle; and communicate with a rental vehicle owned or managed by an owner member who desires to rent out a vehicle and a renter member vehicle owned or managed by a renter member who desires to rent a vehicle, the vehicle management method including: checking a state of the renter member vehicle in response to receipt of an unlocking request notification from the rental vehicle, the unlocking request notification indicting receipt of an unlocking request based on key information for allowing the renter member to temporarily use the rental vehicle; determining that an unlocking condition is satisfied in a case where the renter member vehicle is under management of the vehicle management system; and transmitting unlocking permission information for unlocking an electronic lock of the rental vehicle in a case where the unlocking condition is determined to be satisfied.

According to still another aspect of the present disclosure, there is provided a vehicle that is usable in a vehicle management system that manages a vehicle rentable between users, the vehicle including: a vehicle communication device configured to communicate with a vehicle management device configured to manage the vehicle management system; a processor; and a memory having instructions that, when executed by the processor, cause the vehicle to perform operations including: transmitting an inquiry to the vehicle management device about a state of a renter member vehicle owned or managed by a renter member in response to receipt of an unlocking request based on key information for allowing the renter member who desires to a host vehicle to temporarily use the host vehicle as a rental vehicle; determining that an unlocking condition is satisfied in a case where the renter member vehicle is under management of the vehicle management system based on a response to the inquiry transmitted from the vehicle management device and received through the vehicle communication device; and unlocking an electronic lock of the host vehicle based the key information in a case where the unlocking condition is determined to be satisfied.

According to the present disclosure, in the case where the vehicle is rented between the users of car sharing, further improvement can be realized.

### BRIEF DESCRIPTION OF DRAWINGS

FIG. 1 is a diagram showing a schematic configuration of a vehicle management system according to an embodiment.

FIG. 2 is a sequence diagram (1) illustrating an example of a use form of the vehicle management system according to the embodiment.

FIG. 3 is a sequence diagram (2) illustrating an example of a use form of the vehicle management system according to the embodiment.

FIG. 4 is a diagram showing an example of vehicle information used in the embodiment.

FIG. 5 is a diagram showing an example of reservation management information used in the embodiment.

FIG. 6 is a diagram showing an example of reservation completion information used in the embodiment.

FIG. 7 is a block diagram showing a first example of a functional configuration of a management server according to the embodiment.

FIG. 8 is a block diagram showing a second example of the functional configuration of the management server according to the embodiment.

FIG. 9 is a block diagram showing an example of a functional configuration of a rental vehicle according to the embodiment.

FIG. 10 is a block diagram showing an example of a functional configuration of a renter member vehicle according to the embodiment.

FIG. 11 is a flowchart showing an example of a procedure until reservation is confirmed in the management server according to the embodiment.

FIG. 12 is a flowchart showing an example of a procedure when the rental vehicle is used in the management server according to the embodiment.

FIG. 13 is a flowchart showing an example of a procedure in a terminal of a renter member according to the embodiment.

FIG. 14 is a flowchart showing an example of a procedure in a terminal of an owner member according to the embodiment.

### DETAILED DESCRIPTION

(Findings Leading to Present Disclosure)

In a general car sharing system, a user registers for membership in a system of an administrator of an operator or the like, and makes a reservation, use, and return of the vehicle to the administrator. In this case, the user uses the vehicle owned by the administrator of the system. Here, in the car sharing system, a so-called C2C type car sharing system is assumed in which the vehicles are used and returned between members who have registered as members in a system, that is, between users.

In a case of the car sharing system in which an administrator is present, the administrator prepares a parking lot and a vehicle, and the user uses a target vehicle at the parking lot. On the other hand, in the case of the car sharing system in which a vehicle is used and returned between the users, a vehicle owned by a user who desires to rent out a vehicle (hereinafter, referred to as an owner member) is set as a target vehicle, and a user who desires to rent a vehicle (hereinafter referred to as a renter member) moves to a parking place of the target vehicle in a period in which the owner member can rent, and rents the vehicle of the owner member. In this case, if a credit level of the member, and guarantee of the vehicle or the like as collateral is not secured between the owner member and the renter member, there is a possibility that the system does not appropriately function. For the owner member, if the guarantee is insufficient, the value of the rental vehicle may be damaged in a case where the vehicle is illegally use (resale or the like), unauthorized, lost, stolen, or damaged due to an accident or the like.

In a case of a general car sharing system, the user moves to a parking lot of the vehicle prepared by the administrator, and uses the target vehicle. On the other hand, in a case where the vehicle is rented between the users, since the target vehicle is in a place where the owner member is parked, the parking places are distributed, and the renter member takes time and effort to move to the parking place of the target vehicle every time the renter member use a vehicle, which may result in poor convenience.

Therefore, in view of the above circumstances, the present disclosure shows a configuration example of a vehicle management system that can ensure the guarantee regarding the vehicle rental and can smoothly rent the vehicle between the users.

### Embodiment

Hereinafter, embodiments of a vehicle management system, a vehicle management method, and a vehicle according to the present disclosure will be described in detail with reference to the accompanying drawings as appropriate. However, unnecessarily detailed description may be omitted. For example, detailed description of already well-known matters and redundant description of substantially the same configuration may be omitted. This is to avoid unnecessary redundancy in the following description and facilitate understanding of those skilled in the art. It should be noted that the accompanying drawings and the following description are provided for a thorough understanding of the present disclosure for those skilled in the art, and are not intended to limit the subject matter recited in the claims.

In the following embodiment, as an example of the vehicle management system, a configuration example of a car sharing system in which a vehicle is used and returned between users is shown.

In the vehicle management system of the present embodiment, the member can rent a vehicle owned by another member (owner member), as a renter member. In addition, the member can rent out a vehicle owned by the member himself/herself as an owner member to another member (renter member). It is also possible to rent the vehicle in the same period.

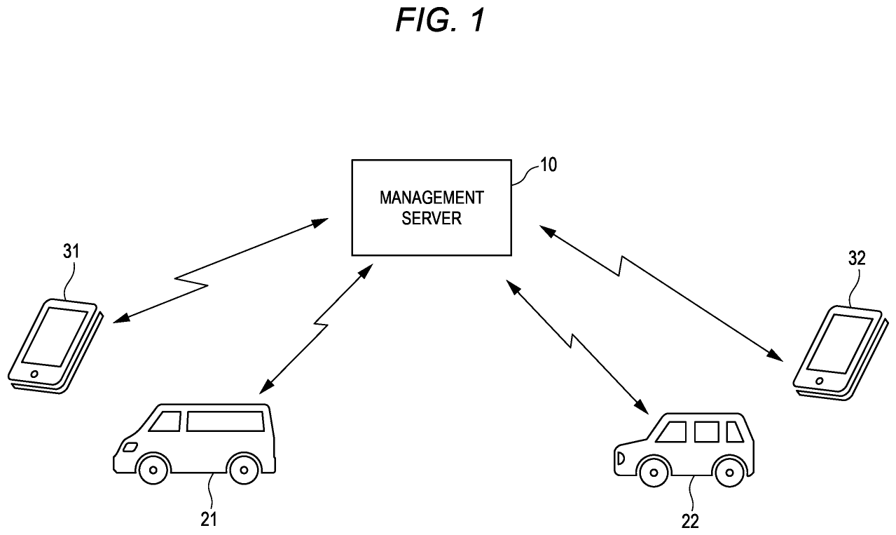

FIG. 1 is a diagram showing a schematic configuration of the vehicle management system according to the embodiment. The vehicle management system includes, as an example of a vehicle management device, a management server 10 that manages member information, vehicle information, reservation information, and the like of the car sharing system. The management server 10 communicates with a vehicle 21 managed by the owner member, a terminal 31 used by the owner member, a vehicle 22 managed by a renter member, a terminal 32 used by the renter member, and the like, and can transmit and receive various information, signals, and the like.

A function of the management server 10 is realized in, for example, a server device including a processing unit such as a processor, a storage unit such as a memory or a storage, a computer having a communication unit, and the like. The processor may include a micro processing unit (MPU), a central processing unit (CPU), a digital signal processor (DSP), a graphical processing unit (GPU), and the like. The memory may include a random access memory (RAM), a read only memory (ROM), and the like. The storage may include a hard disk drive (HDD), a solid state drive (SSD), an optical disk device, a memory card, and the like. The communication unit is a communication interface having a communication function of wireless communication or wired communication, and can transmit and receive various information, signals, and the like via a communication network such as a mobile communication network, the Internet, or a wireless LAN or a communication path such as a communication line.

The management server 10 may implement a plurality of functional blocks using the same hardware resource. In addition, the plurality of functional blocks may be implemented by mutually connecting a plurality of hardware resources.

Noted that the management server 10 as the example of the vehicle management device can also configure its functions in a terminal, a computer, or the like used by a user such as the owner member or the renter member. In addition, the functions of the management server 10 may be realized in a distributed manner in terminals or the like used by a plurality of users. In this case, information and the like can be transmitted and received between users in a peer-to-peer manner without intervention of the server device operated by a system administrator or the like, and reservation, use, return, and the like of the vehicle can be executed.

The owner member and the renter member set the vehicles 21, 22 managed by the owner member and the renter member as target vehicles for car sharing, respectively. In the present embodiment, the target vehicle for car sharing includes a vehicle owned by a member, a vehicle used based on a lease contract, or the like, a vehicle managed by a predetermined contract or the like, or the like. That is, it is assumed that when the target vehicle is not rented out, a member exclusively uses and manages the target vehicle, and enjoys an asset value of the vehicle or is responsible for the asset value.

The vehicles 21, 22 include an electronic control unit (ECU) serving as a processing unit that controls an operation of the vehicle, and a communication unit that transmits and receives various information to and from the management server 10 and the terminals 31, 32. The communication unit is a communication interface having a wireless communication function, and can transmit and receive various information, signals, and the like via a communication network such as a mobile communication network, the Internet, or the wireless LAN or a communication path such as a communication line. In a case where the vehicle is an electric vehicle, the communication unit may perform communication via a charging cable that charges a battery mounted on the vehicle.

As the terminals 31, 32 used by the owner member and the renter member, various terminals such as a mobile terminal carried by a member, a computer located at home of a member, and in-vehicle terminals mounted on the vehicles 21, 22 can be used. The terminals 31, 32 include a processing unit such as a processor, a storage unit such as a memory or a storage, a display unit such as a display, and a communication unit. The display may include a liquid crystal display (LCD), an organic electro luminescence display (OELD), or the like. The communication unit is a communication interface having a wireless communication function, and can transmit and receive various information, signals, and the like via a communication network such as a mobile communication network, the Internet, or the wireless LAN or a communication path such as a communication line.

The owner member and the renter member register the vehicle information necessary for the car sharing system in the management server 10 using the terminals 31, 32 with respect to the vehicles 21, 22 that are the target vehicles, respectively. The owner member inputs rent-out application information necessary for renting out the vehicle 21 to the management server 10 using the terminal 31. As rent-out application information, rental vehicle information, rental place information, rental period information, and the like may be used. The renter member inputs a reservation request including use application information necessary for renting the vehicle from the terminal 32 to the management server 10, and when there is a suitable target vehicle, the renter member makes a reservation for the vehicle to be used. As the use application information, desired vehicle information such as a vehicle type that the user desires to use, use place information, use period information, own vehicle information, and the like may be used. The management server 10 includes a reservation management database for managing the reservation information. The management server 10 receives the reservation request from the renter member, registers the reservation request in the reservation management information, performs matching of the vehicle that suits the reservation request, and transmits reservation completion information to the terminal 32 of the renter member when the reservation is confirmed.

In a case where the renter member uses the vehicle 21 of the owner member, the vehicle 22 of the renter member is parked in a predetermined parking place, and is placed under management of the car sharing system, and moves to a rental place where the vehicle 21 of the owner member is parked. The owner member is able to park his/her own vehicle 21 at a predetermined parking place, place the vehicle 21 under the management of the car sharing system, and use the vehicle 21 as a rental vehicle to be a rental object. The vehicle 21 of the owner member receives the reservation information from the terminal 32 of the renter member, inquires of the management server 10, and in a case where a predetermined unlocking condition is satisfied, unlocks the vehicle to be in a usable state. Further, after the end of use, the renter member returns the vehicle 21 of the owner member to the rental place, and notifies the management server 10 of the use end from the vehicle 21 or the terminal 32. The vehicle 21 of the owner member is locked when the use ends. The management server 10 performs settlement processing of the usage fee and notifies each of the terminals 31, 32 of the settlement processing, respectively. The vehicle 22 of the renter member is released from the management of the car sharing system by the use end and the settlement processing of the vehicle 21 of the owner member, and returns to a state in which a renter member can optionally use the vehicle.

Here, it is assumed that a state in which the car sharing system can grasp a parking state and a use state (unused state) of the target vehicle is under the management of the system. Under the management of the system, the target vehicle of the member is parked at a parking lot of the home, or a specific parking lot (for example, a parking lot of an airport at the time of traveling) in which the target vehicle is placed at the time of non-use, and the member itself or another person cannot freely use it for an optional period. In addition, it is assumed that a state in which availability is guaranteed such as a state in which the member parks the target vehicle in a state in which the target vehicle is rentable to another member, and a state in which the target vehicle is being rented out is under the management of the system.

### Specific Example of System

As a usage scene of the car sharing system according to the present embodiment, for example, a case in which a user uses a vehicle parked at a parking lot of an airport during traveling will be illustrated. It is assumed that the vehicle parked at the parking lot of the airport is not used by its owner for a certain period during traveling. In an absence period of the owner, the parked vehicle can be used for car sharing application. In particular, since a vehicle having an automatic driving function at a level 2 to a level 5 defined by the U.S. National Highway Traffic Safety Administration is expensive, the owner has an advantage of utilizing assets due to the vehicle rental, and it is possible to meet the needs of a user who want to use a safe driving vehicle. In addition, there is an advantage that the operator of the parking lot can also improve a utilization rate of the parking lot.

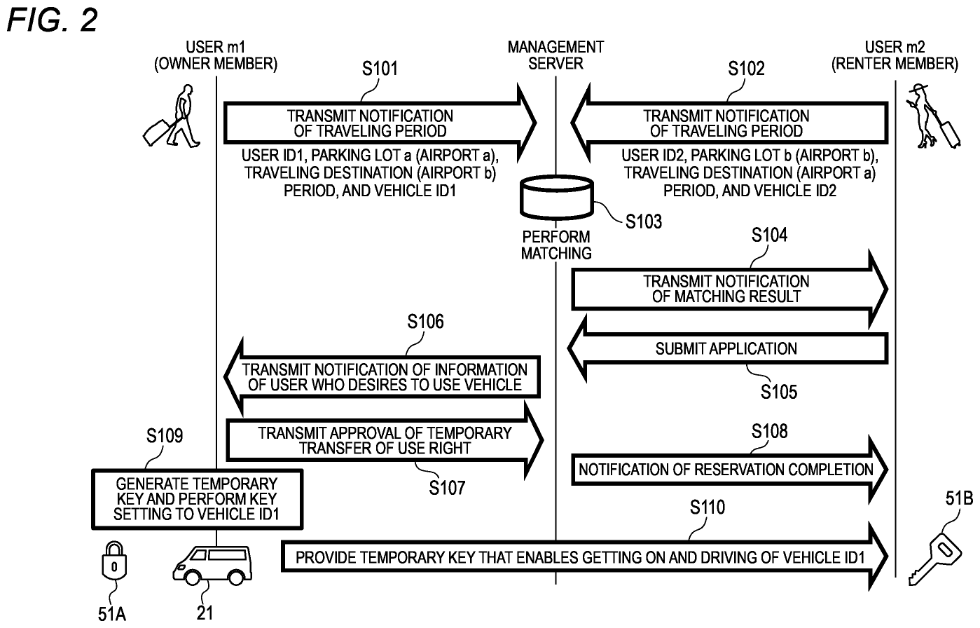

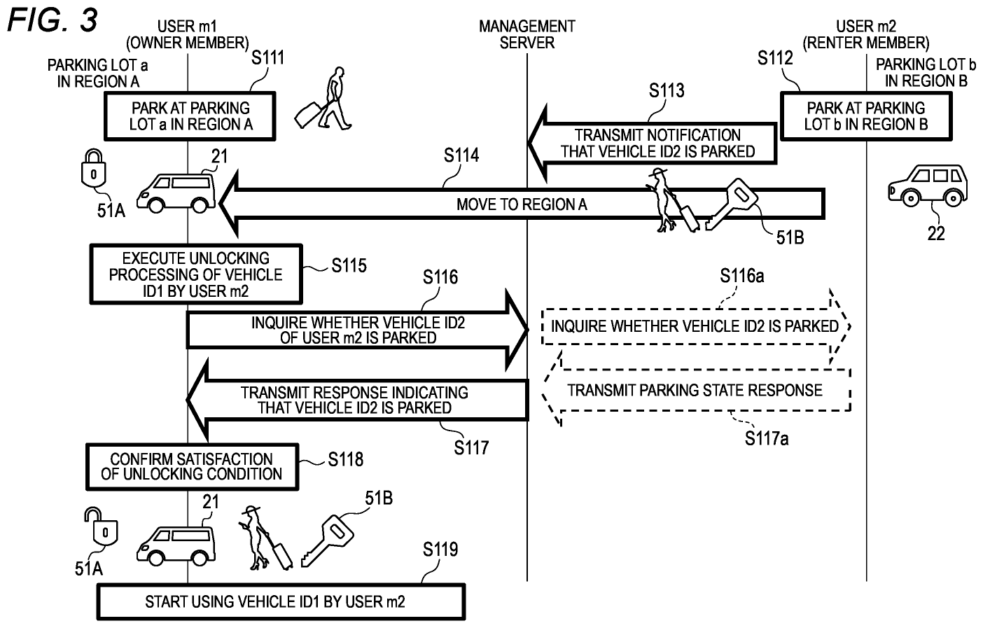

FIGS. 2 and 3 are sequence diagrams illustrating an example of a use form of the vehicle management system according to the embodiment. This example illustrates a procedure in a case where a vehicle parked at a parking lot of an airport is used. In this example, a case is illustrated in which a first user m1 is owner member, a second user m2 is a renter member, and the car sharing system is used during a period in which each of the first user m1 and the second user m2 travels. The owner member and the renter member may be in a form in which the vehicle is rented to and from each other, or may be in a form in which the vehicle is rent out to the renter member only or rented from the owner member only, or various modes in which, for example, the owner member rents the vehicle from another member, the renter member rents out the vehicle to another member, etc., may be considered.

First, in FIG. 2, the user m1 serving as the owner member operates the terminal 31, and notifies the management server 10 of traveling period information as the use application information from the terminal 31 (S101). The traveling period information on the owner side includes member information (user ID1), rental place information (host vehicle position information) (parking lot a (region A, airport a)), use place information (traveling destination (region B, airport b), rental period information (traveling period), rental vehicle information (host vehicle information) (vehicle ID1). As a result, the user ml registers, in the management server 10, that he/she intends to rennet out his/her own vehicle for the car sharing application during the traveling period. The terminal 31 transmits the use application information to the management server 10. At this time, when the user ml travels to the region B, the user ml moves to the parking lot a of the airport a of the region A by the vehicle with the vehicle ID1. The vehicle with the vehicle ID1 is in a state of being parked at the parking lot a and being under the management of the system during a period from a departure time T1d to a return time T1a of the user ml, and is permitted to be used as a rental vehicle for another member. In a case where the user ml desires to use a vehicle of another member and becomes a renter member, the same procedure as that of the user m2 is also executed.

The user m2 serving as the renter member operates the terminal 32, and notifies the management server 10 of traveling period information as use application information from the terminal 32 (S102). The traveling period information on the renter side includes member information (user D2), host vehicle position information (parking lot b (region B, airport b)), use place information (traveling destination (region A, airport a), use period information (traveling period), desired vehicle information, and collateral vehicle information (host vehicle information (vehicle ID2)). As a result, the user m2 registers, in the management server 10, that he/she desires to use a vehicle of another member vehicle during the traveling period and that he/she intends to place his/her own vehicle under the management of the car sharing system during a rental. The terminal 32 transmits the use application information to the management server 10, and inquires of the management server 10 whether there is a vehicle that can be used during the traveling period in the region A of the traveling destination. At this time, when the user m2 travels to the region A, the user m2 moves to the parking lot b of the airport b of the region B by the vehicle with the vehicle ID2. The vehicle with the vehicle ID2 is in a state of being parked at the parking lot b and being under the management of the system during a period from a departure time T2d to a return time T2a of the user m2, and is permitted to be in a state of being a collateral vehicle. When the user m2 rents out his/her own vehicle and becomes an owner member, the same procedure as that of the user ml is also executed.

The management server 10 registers the use application information from each member in the reservation management database as reservation management information. When the management server 10 receives the use application information from the user m2, the management server 10 performs matching processing of the registered reservation management information with reference to the reservation management database (S103), searches for a vehicle matching a use condition from the reservation management information, and extracts that the vehicle 21 with the vehicle ID1 of the user ml matches the use condition. Then, the management server 10 notifies the terminal 32 of the user m2 of a matching result indicating a suitable state of the use condition such as the use place and the use period (S104). The terminal 32 displays the matching result of the use application on the display unit, and receives an operation of the user m2. The user m2 refers to the matching result, and in a case where there is a target vehicle (in this case, the vehicle 21 with the vehicle ID1) that matches the desired place, a period, a vehicle type, or the like, the user m2 makes a reservation application by operating the terminal 32. When the terminal 32 receives the reservation application operation of the user m2, the terminal 32 transmits a reservation request for requesting the use of the target vehicle to the management server 10, and makes an application for the reservation (S105).

Upon receiving the reservation request from the user m2, the management server 10 notifies the terminal 31 of the user m1 of the information of the user (user m2) who desires to use the vehicle to the member (user m1) to be reserved (S106). The terminal 31 displays the reservation request information from the user who desires to use the vehicle on the display unit, and receives an operation of the user m1. The user m1 refers to the reservation request information and in a case where the user ml permits the rental of his/her own vehicle, the user ml makes rental approval by operating the terminal 31. When the terminal 31 receives an approval operation of the user ml, the terminal 31 transmits rental permission information of the vehicle to the management server 10, and approves the temporary transfer of the use right (S107). When the management server 10 receives the rental approval from the user m1, the management server 10 transmits the reservation completion information to the terminal 32 of the user m2, and transmits a notification that the rental approval is made by the user m1 in response to the reservation request of the user m2 and the reservation has been completed (S108).

When the rental approval is made by the user m1, an electronic key 51B including a reservation number or the like as key information (temporary key) for temporarily using the vehicle with the vehicle ID1 is issued in the vehicle 21 (vehicle ID1) or the terminal 31 owned or managed by the user ml, and a paired electronic lock 51A is set for the vehicle 21 (S109). Then, the vehicle 21 transmits and provides the electronic key 51B that enables getting on the vehicle with the vehicle ID1 and driving the vehicle to the terminal 32 of the user m2 (S110). The management server 10 may issue the electronic key 51B and transmit the electronic key 51B to the terminal 32 of the user m2. Further, an instruction to issue an electronic key may be transmitted from the management server 10 to the vehicle 21 or the terminal 31 to issue the electronic key 51B.

Subsequently, in FIG. 3, the user ml serving as the owner member parks the vehicle 21 with the vehicle ID1 in which the key information of the temporary key for rent is set at the parking lot a of the region A (S111), and moves to the region B for traveling.

The user m2 serving as the renter member parks the vehicle 22 (vehicle ID2) owned or managed by the user m2 at the parking lot b in the region B (S112). The vehicle 22 notifies the management server 10 that the vehicle ID2 is in a parking state at the parking lot b (S113). By this parking state notification, the vehicle 22 with the vehicle ID2 is placed under the management of the car sharing system in a state where the vehicle 22 is parked at a predetermined place.

The user m2 moves to the region A for traveling, and operates the terminal 32 to perform a use start operation of the vehicle 21 in order to use the vehicle 21 with the vehicle ID1 parked at the parking lot a. When the terminal 32 receives the use start operation of the user m2, the terminal 32 executes unlocking processing of the electronic lock 51A of the vehicle 21 with the vehicle ID1 using the electronic key 51B transmitted and acquired from the vehicle 22 (S115).

When the vehicle 21 receives an unlocking request by the electronic key 51B, the vehicle 21 transmits an unlocking request notification to the management server 10, and checks the parking state of the vehicle 22 with the vehicle ID2 of the user m2 in the management server 10 as a state check of the vehicle of the renter member (S116). When the management server 10 receives a parking state check request of the vehicle 22 (vehicle ID2) of the renter member from the vehicle 21 of the owner member, the management server 10 returns a parking state response indicating that the vehicle 22 with the vehicle ID2 is in the parking state at the predetermined place to the vehicle 21 based on the parking state notification received in advance (S117).

Note that the management server 10 may transmit the parking state check request to the vehicle 22 with the vehicle ID2 at a time point when the parking state check request of the vehicle of the renter member is received from the vehicle 21 of the owner member (S116a). Then, the management server 10 may receive a parking state response indicating that the vehicle 22 with the vehicle ID2 is in the parking state at the predetermined place (S117a), and may return the parking state response to the vehicle 21. Note that the parking state checked may be executed between the vehicle 21 or the terminal 31 of the owner member and the vehicle 22 or the terminal 32 of the renter member without intervention of the management server 10.

The vehicle 21 determines that the vehicle 22 is under the management of the car sharing system by receiving the parking state response of the vehicle 22 with the vehicle ID2, and determines that the unlocking condition of the electronic lock 51A of the vehicle is satisfied (S118). The unlocking condition (the state in which the vehicle 22 is under the management of the system) may be determined in the management server 10, and unlocking permission information may be transmitted to the vehicle 21 in the case where the unlocking condition is satisfied. Then, the vehicle 21 unlocks the electronic lock 51A with the electronic key 51B presented from the terminal 32 of the user m2, and enables the user m2 to get on and operate the vehicle 21 with the vehicle ID1. The user m2 starts using the vehicle 21 with the vehicle ID1 (S119).

According to the above procedure, the user m2 serving as the renter member places his/her own vehicle 22 with the vehicle ID2 under the management of the system in a state in which his/her own vehicle 22 is parked at the predetermined place, and uses the vehicle of the owner member in a state in which his/her own vehicle 22 is used as collateral when the vehicle is rent. The user m1 serving as the owner member can allow the renter member to use his/her own vehicle 21 with the vehicle ID1 in a state in which the vehicle of the renter member is placed under the management of the system and the guarantee when the vehicle is rented out is ensured. In this way, the state in which the renter member (user m2) parks his/her own vehicle 22 at the predetermined place is set as the unlocking condition of the vehicle 21 of the owner member (user m1). As a result, the guarantee of the existence of the user m2 and the asset value of the vehicle 22 are used as collateral, and a deterrent force for preventing the user m2 from illegally using the vehicle 21 (resale, or the like) is exerted. According to the present embodiment, the vehicle can be smoothly rented in a state in which the guarantee at the time of use is ensured without increasing time and effort, between the user m1 and the user m2.

(Various Information Used in System)

Next, various information used in the vehicle management system of the present embodiment will be illustrated. In the car sharing system according to the present embodiment, the owner member rents out his/her own vehicle to another member (renter member) as a target vehicle for car sharing and allows the other member (renter member) to use the vehicle. The owner member provides vehicle information, parking position information, and the like of his/her own vehicle to the management server 10 for renting out the vehicle. The renter member places his/her own vehicle under management of the system and rents and uses the vehicle of the other member (owner member). The renter member provides vehicle information, parking position information, and the like of his/her own vehicle to the management server 10 for the vehicle rental.

The owner member provides the management server 10 with the host vehicle information (rental vehicle information) owned or managed by the owner member as the vehicle information of a target to be rented out. The host vehicle information includes vehicle information such as a model code, model year, and accessories of the vehicle. Further, the owner member provides the parking position information of the host vehicle to the management server 10. The parking position information provides position information of the parking lot associated with the rental period, such as the parking lot of the home of the owner member, the parking lot at which the vehicle is to be parked at the time of pickup, or the like.

The renter member provides the management server 10 with the host vehicle information (collateral vehicle information) owned or managed by the renter member as the vehicle information that is targeted for the collateral at the time of the rental. The host vehicle information includes vehicle information such as a model code, model year, and accessories of the vehicle. Further, the renter member provides the parking position information of the host vehicle to the management server 10. The parking position information provides the position information of the parking lot associated with the use period, such as the parking lot of the home of the renter member, the parking lot at which the vehicle is to be parked at the time of use, or the like.

The host vehicle information of the owner member and the renter members is registered in the management server 10 and managed as member vehicle information, and when the car sharing system is used, it is possible to compare the vehicle values of each other and use it for setting the usage fee and adjusting a difference amount. The parking position information of the vehicle of the owner member can specify a vehicle location at the time of use, such as the location where the renter member can go, a location where the renter member can use a vehicle, or a location where the vehicle should be returned. The parking position information of the vehicle of the renter member can be used as a guarantee to the owner (owner member) of the rental vehicle by certifying that the vehicle that is targeted for the collateral is real rather than fictitious. The parking position information of the vehicle of each member is stored as the member vehicle parking position information in the management server 10. The host vehicle information may include information such as an activation state of a power unit such as an engine or a motor, a capacity of a fuel or a battery, and the presence or absence of a failure, which can be used for determining that the vehicle is under the management of the system or determining whether the vehicle is actually available.

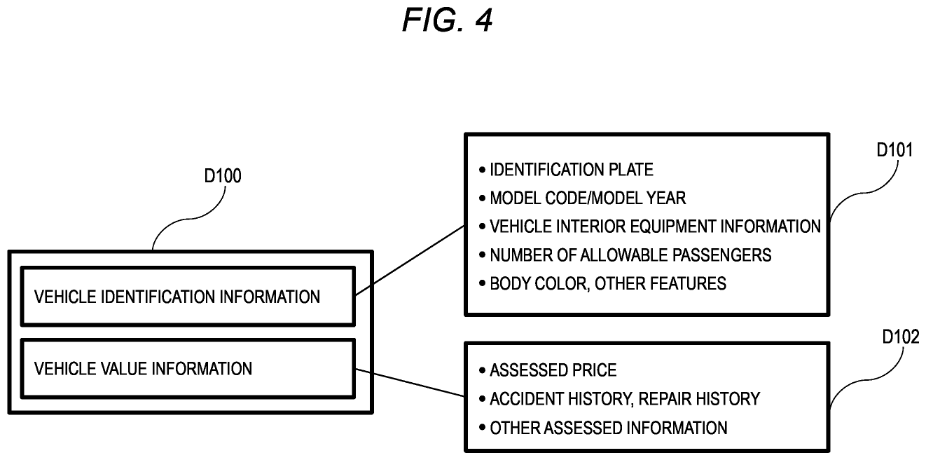

FIG. 4 is a diagram showing an example of the member vehicle information used in the embodiment. Member vehicle information D100 is information for specifying the vehicle owned by the member. The member vehicle information D100 includes vehicle identification information D101 and vehicle value information D102.

The vehicle identification information D101 includes information on a vehicle of each member such as an identification plate, a model code/model year, vehicle interior equipment information, the number of allowable passengers, a body color, and other features. The vehicle interior equipment information includes a child seat or the like. The maximum number of seats can be specified from the model, but the number of allowable passengers is set in consideration of the reduction in the number of allowable passengers due to the installation of child seats.

The vehicle value information D102 includes information on the value of the vehicle of each member, such as an assessed price, an accident history, a repair history, and other assessed information. The assessed price is set from an assessed price in the used vehicle market or the like based on the model code, model year, accessories, and the like of the target vehicle. In a case where the assessed price cannot be acquired from the used vehicle market, the price obtained by deducting an amount equivalent to the depreciation cost in consideration of the aging from the purchase price to the current time is set. The other assessed information is optional, and may include, for example, an item that contributes to the determination of the vehicle value, such as the presence or absence of fine scratches and the total number of kilometers traveled.

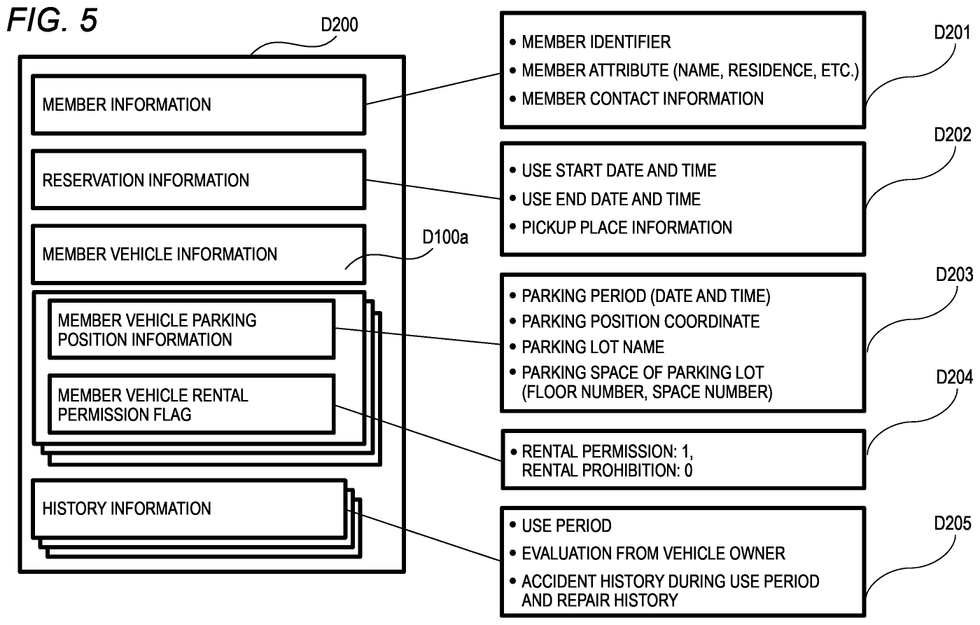

FIG. 5 is a diagram showing an example of the reservation management information used in the embodiment. The reservation management information D200 is registration data of the use application information that is one record of the reservation management database stored in the management server 10. The reservation management information D200 includes member information D201, reservation information D202, member vehicle information D100a, member vehicle parking position information D203, a member vehicle rental permission flag D204, and history information D205.

The member information D201 includes information on identification of each member such as a member identifier, a member attribute (name, residence, and the like), and member contact information. The member information D201 may include information on reliability based on an evaluation from another user. The reservation information D202 includes information on reservation of use of the vehicle such as a use start date and time, a use end date and time, and pickup place information. The pickup place information is position information indicating a use start/end place of the vehicle.

The member vehicle information D100a is vehicle information of each member shown in FIG. 4, and the latest information at a time point of reservation is registered and updated in consideration of a change in aging of the vehicle, a change in the vehicle interior equipment, and the like. The member vehicle parking position information D203 includes information on a parking time and a parking position of the target vehicle owned or managed by the member, such as a parking period (date and time), a parking position coordinate, a parking lot name, and a parking space in the parking lot (floor number, space number) of the vehicle of each member. The parking period is information indicating a period during which the member can the vehicle. The member vehicle rental permission flag D204 sets “1” in a case of rental permission and “0” in a case of prohibition, in consideration of a case where the vehicle owned by the member is not rented to another user.

The history information D205 includes histories of various information in use at the time of past reservation such as a use period, a traveling history at the time of use, an accident history during the use period, a repair history, and reliability based on an evaluation from another user. In addition, the traveling history may include a capacity of the fuel or the battery. There may be a plurality of pieces of history information.

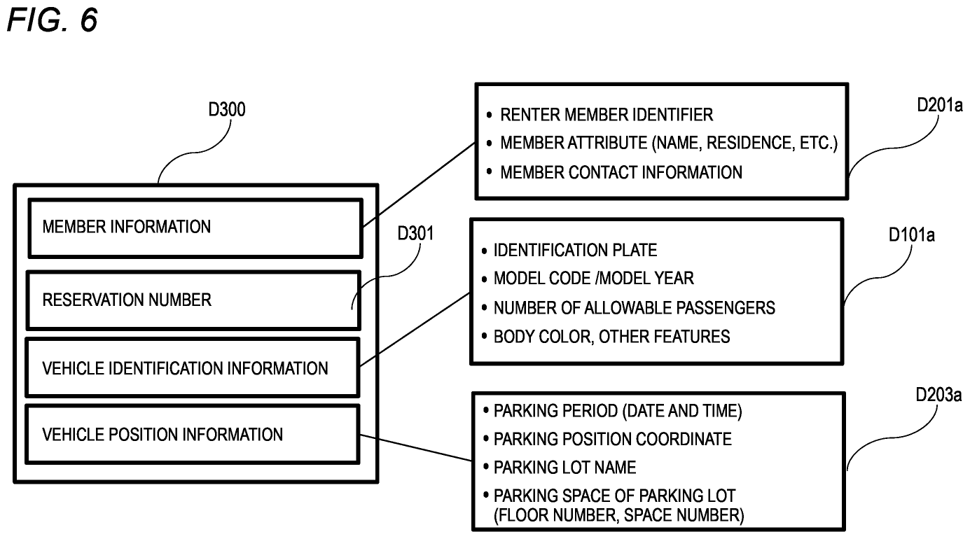

FIG. 6 is a diagram showing an example of the reservation completion information used in the embodiment. The reservation completion information D300 is information provided to the renter member after the reservation of the vehicle to be used is confirmed. The reservation completion information D300 includes member information D201a, a reservation number D301, vehicle identification information D101a, and vehicle position information D203a.

The member information D201a is information on identification of a renter member, and includes a renter member identifier, a member attribute (name, residence, and the like), member contact information, and the like. The reservation number D301 is a number issued corresponding to a reservation content for which the reservation has been confirmed, and may include characters such as characters and symbols (reservation code).

The vehicle identification information D101a is information on identification of a vehicle of an owner member who has made use reservation, and includes information such as an identification plate, a model/year, the number of allowable passengers, a body color, and other features. The vehicle position information D203a is position information on the vehicle of the owner member who has made the use reservation, and includes information such as a parking period (date and time), a parking position coordinate, a parking lot name, a parking space of the parking lot (floor number, space number), and the like.

The renter member finds a target vehicle of the owner member reserved by the vehicle identification information D101a and the vehicle position information D203a. The renter member inputs a reservation number with a reservation number input device (a touch pad, a key pad, or the like) provided in his/her own terminal 32 or the vehicle 21, and unlocks the lock of the door of the vehicle 21. At this time, the reservation number may be used as the key information of the temporary key, or a two-dimensional code, electronic key information, or the like having authentication information including the reservation number may be used as the key information. In this case, it is assumed that a physical key for starting an engine and locking a door of the vehicle is stored in the vehicle.

(Functional Configuration of System)

Next, a functional configuration of each constituent element in the vehicle management system according to the present embodiment will be illustrated.

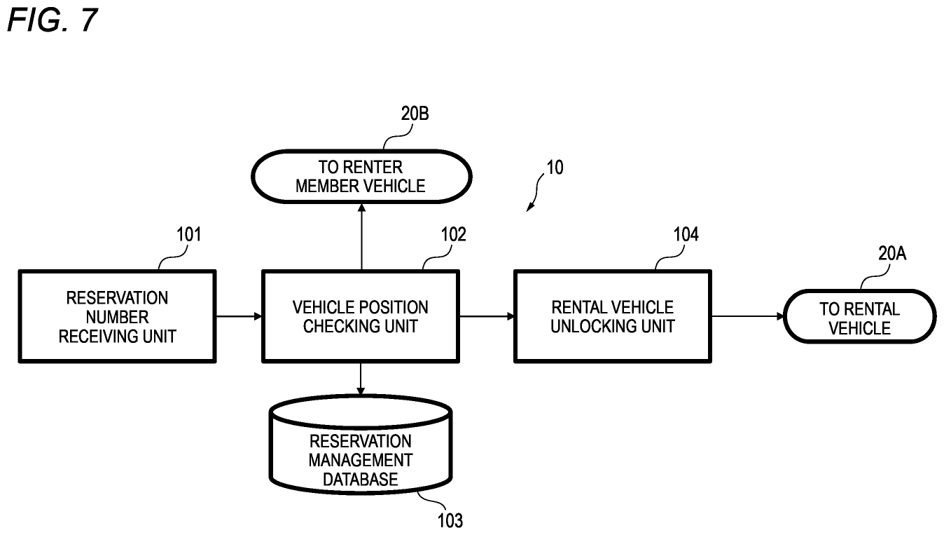

FIG. 7 is a block diagram showing a first example of a functional configuration of the management server according to the embodiment. FIG. 7 shows functional blocks related to unlocking confirmation processing when a renter member uses a rental vehicle of an owner member in the management server 10. Each function block realizes a function thereof by executing a predetermined processing operation in a processing unit, a storage unit, and a communication unit provided in the management server 10. In the following example, a case in which a reservation number is used as the key information at the time of vehicle use will be illustrated.

The management server 10 includes a reservation number receiving unit 101, a vehicle position checking unit 102, a reservation management database 103, and a rental vehicle unlocking unit 104. The reservation number receiving unit 101 receives an input event of a reservation number from a rental vehicle 20A (vehicle 21). The reservation number is input by the reservation number input device included in the rental vehicle, and is transmitted from the rental vehicle to the management server 10, when the renter member uses the rental vehicle. The reservation number may be input to the rental vehicle by the terminal 32 of the renter member and transmitted to the management server 10.

When receiving the input event of the reservation number from the reservation number receiving unit 101, the vehicle position checking unit 102 extracts the reservation management information D200 corresponding to the reservation number with reference to the reservation management database 103, and acquires the member information, the reservation information, and the member vehicle parking position information of the renter member. The vehicle position checking unit 102 acquires the vehicle position of the renter member at the current time point and checks whether the vehicle is in the parking state at a predetermined parking place based on the member vehicle parking position information, and determines whether the rental is permitted or not permitted. The vehicle position checking unit 102 may acquire the current position of a renter member vehicle 20B and determine the parking state of the renter member vehicle 20B by transmitting a position information detection request to the vehicle of the renter member (renter member vehicle 20B) and performing the inquiry.

The rental vehicle unlocking unit 104 determines whether the rental permission is determined, that is, whether the unlocking condition of the rental vehicle is satisfied, based on a checking result of the parking state by the vehicle position checking unit 102, and transmits the unlocking permission information to the rental vehicle 20A in a case where the unlocking condition is satisfied.

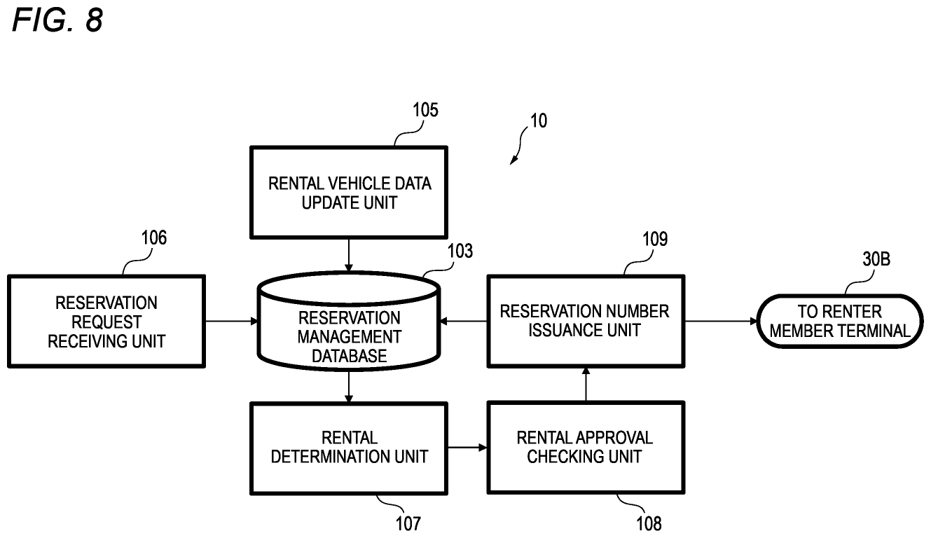

FIG. 8 is a block diagram showing a second example of the functional configuration of the management server according to the embodiment. FIG. 8 shows functional blocks related to reservation confirmation processing when a renter member reserves a vehicle to be used in the management server 10.

The management server 10 includes a rental vehicle data update unit 105, a reservation request receiving unit 106, the reservation management database 103, a rental determination unit 107, a rental approval checking unit 108, and a reservation number issuance unit 109. The rental vehicle data update unit 105 acquires the member vehicle parking position information from the rental vehicle 20A (vehicle 21), and updates the member vehicle information D100 in the reservation management information stored in the reservation management database 103. The reservation request receiving unit 106 receives the reservation request information from the terminal 32 of the renter member, and registers the reservation management information including the reservation information D202 in the reservation management database 103.

With reference to the reservation information D202 of the reservation management information registered by the renter member and the member vehicle parking position information D203 of the owner member stored in advance, the rental determination unit 107 searches for a target vehicle that matches the use condition of the reservation request, and determines whether the target vehicle matching the use condition can be rented out. The rental approval checking unit 108 checks the rental approval of the rental vehicle 20A with reference to the member vehicle rental permission flag D204 of the owner member.

The rental approval checking unit 108 may check a rental approval condition based on the use history by the history information D205 of the renter member, the reliability by the member information D201, and the renter member information such as the asset value of the renter member vehicle by the member vehicle information D100. In addition, the rental determination unit 107 may set a condition of the target vehicle that matches a reservation request, such as setting a vehicle type that can be used by the renter member in accordance with the asset value of the renter member vehicle, and setting a vehicle type and a use period that can be used by the renter member in accordance with the reliability of the renter member.

In a case where the rental approval is confirmed by the rental approval checking unit 108, the reservation number issuance unit 109 newly issues a reservation number D301, and updates the reservation management database 103. The reservation number issuance unit 109 notifies the terminal 32 (renter member terminal 30B) of the renter member of the reservation number.

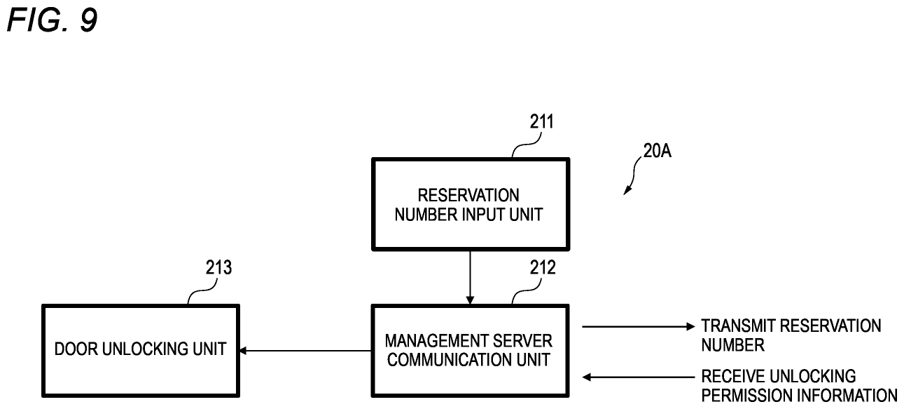

FIG. 9 is a block diagram showing an example of a functional configuration of the rental vehicle according to the embodiment. FIG. 9 shows functional blocks related to the unlocking processing of the electronic lock in the rental vehicle 20A. Each function block realizes a function thereof by executing a predetermined processing operation in a processing unit and a communication unit provided in the rental vehicle 20A.

The rental vehicle 20A includes a reservation number input unit 211, a management server communication unit 212, and a door unlocking unit 213. A function of a key information processing unit is realized by the reservation number input unit 211, and a function of an unlocking processing unit is realized by the management server communication unit 212 and the door unlocking unit 213. The reservation number input unit 211 includes the reservation number input device such as a touch pad, and a keypad, and inputs the reservation number by the input operation of the renter member. The reservation number input unit 211 may include a communication unit that receives and inputs a reservation number transmitted from the terminal 32 of the renter member. The management server communication unit 212 includes a communication unit capable of communicating with the management server 10, transmits the reservation number to the management server 10, and receives the unlocking permission information from the management server 10. The door unlocking unit 213 unlocks the electronic lock of the vehicle in a case where the unlocking permission information is received from the management server communication unit 212.

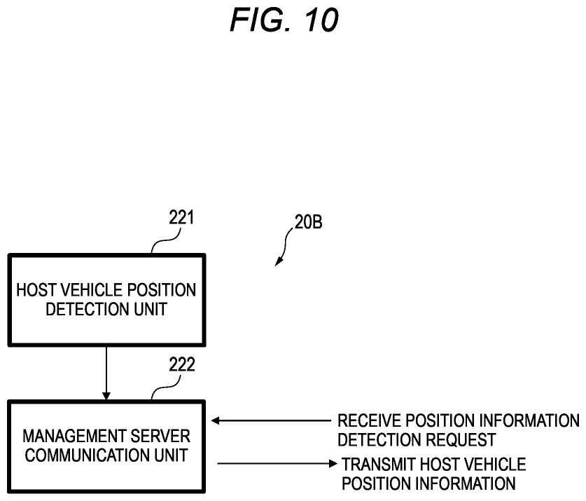

FIG. 10 is a block diagram showing an example of a functional configuration of the renter member vehicle according to the embodiment. FIG. 10 shows functional blocks related to parking state checking processing for checking presence of the vehicle in the renter member vehicle 20B. Each function block realizes a function thereof by executing a predetermined processing operation in a processing unit and a communication unit provided in the renter member vehicle 20B.

The renter member vehicle 20B includes a host vehicle position detection unit 221 and a management server communication unit 222. The host vehicle position detection unit 221 detects the position of the host vehicle based on a positioning system using a global navigation satellite system (GNSS) or the like, a combination of the positioning system and map information, a communication result (reception strength or the like) between a mobile communication or a base station of a wireless LAN, and the like. As the host vehicle position detection unit 221, one provided in an in-vehicle navigation system or the like can be used. The management server communication unit 222 includes a communication unit capable of communicating with the management server 10, receives the position information detection request from the management server 10, and transmits the host vehicle position information acquired by the host vehicle position detection unit 221 to the management server 10.

### Operation Example of System

Next, an operation procedure of each constituent element in the vehicle management system according to the present embodiment will be illustrated.

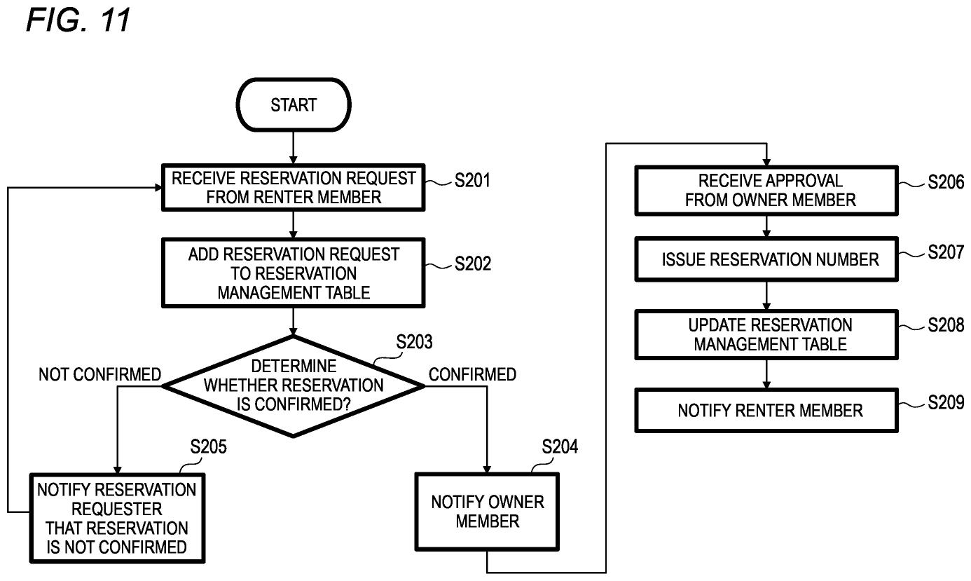

FIG. 11 is a flowchart showing an example of a procedure until the reservation is confirmed in the management server according to the embodiment. The management server 10 receives the reservation request from the terminal 32 (renter member terminal 30B) of the renter member (S201). Then, the management server 10 additionally registers the reservation management information, which is the use application information of the received reservation request, in a reservation management table of the reservation management database 103 (S202). Next, the management server 10 performs the matching process of the reservation management information, and determines whether the target vehicle matching the use condition of the reservation request is present and can be rented out, and the reservation is confirmed (S203). In a case where the reservation is confirmed, the management server 10 transmits a rental approval request corresponding to the reservation request to the terminal 31 of the owner member that owns or manages the target vehicle to be the rental vehicle, and notifies the terminal 31 of the rental approval request (S204). On the other hand, in a case where there is no target vehicle that matches the use condition of the reservation request and the reservation is not confirmed, the management server 10 notifies the terminal 32 of the renter member that has transmitted the reservation request that the reservation is not confirmed (S205).

When the management server 10 receives rental approval information from the terminal 31 of the owner member (S206), the management server 10 issues a reservation number corresponding to the reservation request (S207). Subsequently, the management server 10 inputs the reservation management information including the issued reservation number to the reservation management database 103, and updates the reservation management table of the reservation management database 103 (S208). Then, the management server 10 transmits the reservation number to the terminal 32 of the renter member and notifies the terminal 32 of the reservation number (S209).

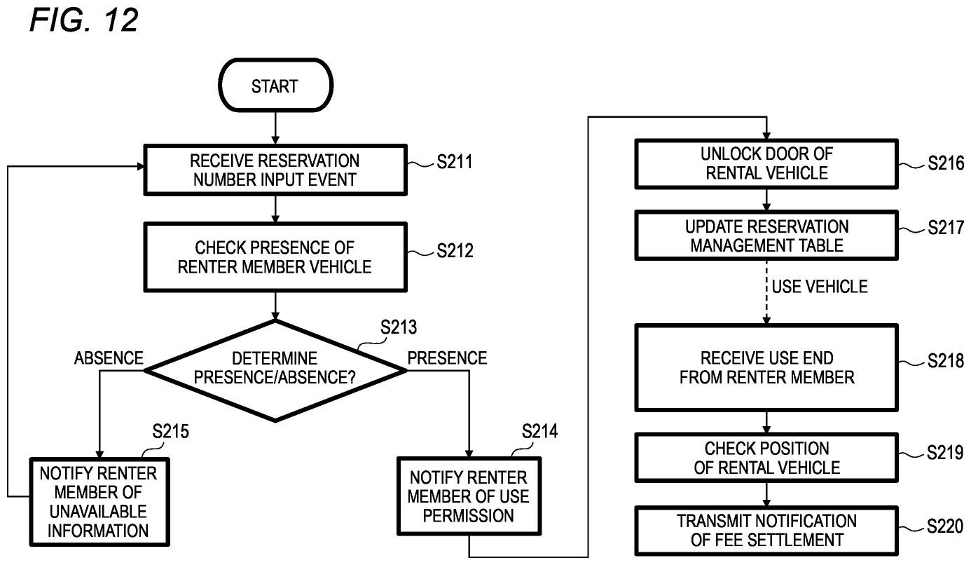

FIG. 12 is a flowchart showing an example of a procedure when a rental vehicle is used in the management server according to the embodiment. When the management server 10 receives a reservation number input event as the unlocking request notification from the vehicle 21 (rental vehicle 20A) of the owner member (S211), the management server 10 checks the parking state by, for example, acquiring the position information of the vehicle of the renter member corresponding to the reservation number, and checks the presence of the renter member vehicle 20B (S212). The management server 10 determines whether the presence of the renter member vehicle 20B is confirmed (S213), and in a case where the renter member vehicle 20B is present, the management server 10 transmits the use permission information to the terminal 32 of the renter member and notifies the terminal 32 of the renter member of the use permission information (S214). On the other hand, in a case where the management server 10 determines that the parking state of the renter member vehicle 20B cannot be confirmed and determines that the renter member vehicle 20B is not present, the management server 10 transmits unavailable information to the terminal 32 of the renter member and notifies the terminal 32 of the renter member of the unavailable information (S215).

In a case where the parking state of the renter member vehicle 20B is checked and the unlocking condition is satisfied, the management server 10 transmits the unlocking permission information to the rental vehicle 20A and causes the door of the rental vehicle 20A to be unlocked (S216). Then, the management server 10 inputs the reservation management information including use start information of the rental vehicle 20A to the reservation management database 103, and updates the reservation management table of the reservation management database 103 (S217). Then, the rental vehicle 20A is used by the renter member.

When the management server 10 receives use end information from the terminal 32 (renter member terminal 30B) of the renter member (S218), the management server 10 checks the position of the rental vehicle 20A by, for example, acquiring the position information of the rental vehicle 20A (S219). In a case where the rental vehicle 20A is at a predetermined parking place to be returned, the management server 10 executes fee settlement processing related to vehicle use, and notifies the terminal 32 of the renter member and the terminal 31 of the owner member, respectively (S220).

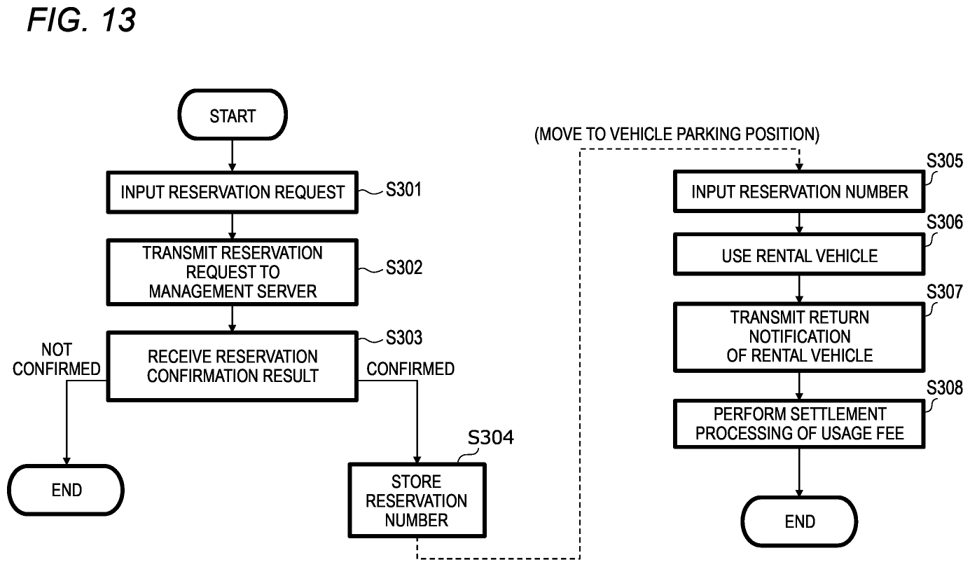

FIG. 13 is a flowchart showing an example of a procedure in the terminal of the renter member according to the embodiment. The terminal 32 (renter member terminal 30B) of the renter member inputs the reservation request by the input operation of the renter member (S301). When receiving the input of the reservation request, the terminal 32 transmits the reservation request to the management server 10 (S302). Then, the terminal 32 receives a reservation confirmation result from the management server 10 (S303). In a case where the reservation is not confirmed, the terminal 32 receives reservation failure notification from the management server 10. On the other hand, in a case where the reservation is confirmed, the terminal 32 receives the reservation number from the management server 10 and stores the reservation number in the storage unit (S304).

The renter member moves to the parking place of the reserved rental vehicle 20A, and inputs the reservation number in the rental vehicle 20A by the operation of the reservation number input unit of the rental vehicle 20A or the reservation number input operation using the terminal 32 (S305). In a case where the unlocking condition is satisfied by checking the parking state of the renter member vehicle 20B, the unlocking processing of the rental vehicle 20A, which is a reserved vehicle, is performed, and the rental vehicle 20A can be used (S306). When the renter member ends the use of the rental vehicle 20A and the renter member performs operation for return of the vehicle by locking the rental vehicle 20A or the like, the terminal 32 transmits vehicle return information to the management server 10 and performs a return notification (S307). Then, in the management server 10, the position of the rental vehicle 20A is checked (return check), and the fee settlement processing related to vehicle use is executed. The terminal 32 receives settlement information of the usage fee (S308).

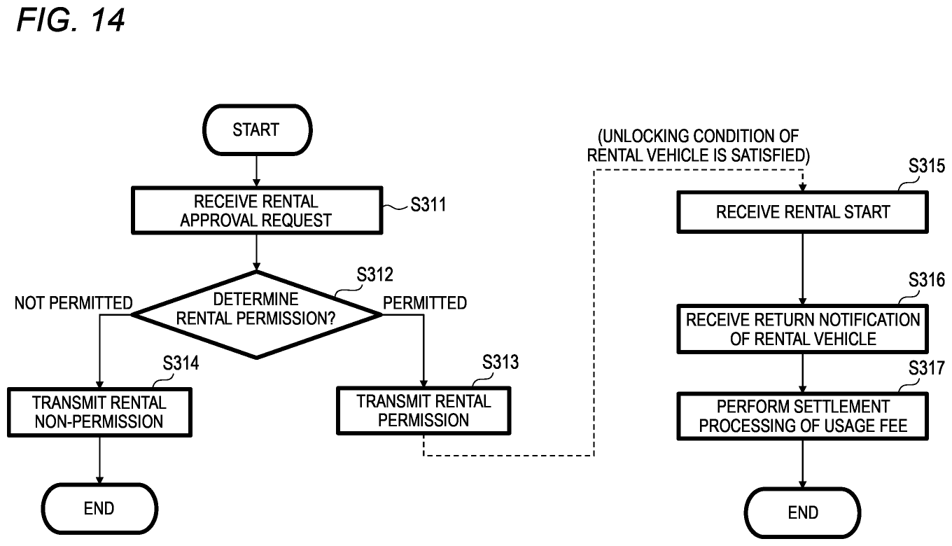

FIG. 14 is a flowchart showing an example of a procedure in the terminal of the owner member according to the embodiment. When the terminal 31 of the owner member receives the rental approval request corresponding to the reservation request of the renter member from the management server 10 (S311), the terminal 31 of the owner member determines the rental permission of the rental vehicle 20A based on an approval input operation by the owner member, the confirmation of a predetermined rental approval condition, and the like (S312). In a case where it is determined that the rental is permitted, the terminal 31 transmits the rental permission information to the management server 10 (S313), and issues a reservation number in the management server 10. On the other hand, in a case where it is determined that the rental is not permitted, the terminal 31 transmits the rental non-permission information to the management server 10 (S314), and notifies the terminal 32 of the renter member that the rental is not permitted.

When the renter member moves to the parking place of the rental vehicle 20A and inputs the reservation number to the rental vehicle 20A, the unlocking condition is satisfied, and the unlocking processing of the rental vehicle 20A is executed, the terminal 31 receives rental start information from the management server 10 (S315). Then, when the renter member uses the rental vehicle 20A and the rental vehicle 20A is returned after use, return checking processing is executed in the management server 10, and the terminal 31 receives the return notification of the rental vehicle 20A (S316). Then, in the management server 10, the fee settlement processing related to the vehicle use is executed, and the terminal 31 receives the settlement information of the usage fee (S317).

In setting of the usage fee, the vehicle value of the vehicle 21 owned or managed by the owner member may be compared with the vehicle value of the vehicle 22 owned or managed by the renter member, and fee setting, the difference amount adjustment of the usage fee, and the like may be performed. For example, various fee settings may be implemented, such as setting a high usage fee in a case where the vehicle value of the vehicle 21 of the owner member is high, setting a high usage fee in a case where the vehicle value of the vehicle 22 of the renter member is low, and setting a low usage fee in a case where the vehicle value of the vehicle 22 of the renter member is high, and setting a usage charge in accordance with the difference in vehicle value between the both vehicles 21, 22. In addition, depending on the vehicle value of the vehicle 22 of the renter member, the use condition corresponding to the vehicle value may be set, such as a vehicle type and a period of an available vehicle are limited, or a selection range is enlarged. In addition, depending on the reliability between the users, a determination condition of the rental permission, an authentication condition of the key information, and the like may be changed, and a use form according to the reliability may be set.

According to the present embodiment, in the case where the vehicle is rented between the users of the car sharing system, the owner member can ensure the guarantee regarding the vehicle rental based on a state check of the vehicle of the renter member who desires to use the vehicle, and can rent out the host vehicle. Therefore, in the C2C type car sharing system, illegal use on the renter side can be suppressed, and a risk on the owner side can be reduced. At this time, the vehicle can be smoothly rented between the users without increasing preparation, the procedure, and the like for ensuring the guarantee. Therefore, it is possible to improve convenience of the car sharing system.

The fact that the renter member has been parked his/her own vehicle at the predetermined place is set as the unlocking condition of the rental vehicle, so that it is possible to ensure the guarantee of the existence of the renter member and the renter member vehicle, to use the asset value of the renter member vehicle as collateral, and to exert the deterrent force to the illegal use of the rental vehicle by the renter member.

The management server is configured to be operated by a third party, and the third party mediates the vehicle rental between the users, so that anonymity between the users can also be maintained.

When the user takes a trip, the vehicle is rented using a parking lot of an airport or a station, so that it is possible to obtain effects such as an improvement in convenience of the vehicle user, an asset utilizing merit of a vehicle owner, and an improvement in the utilization rate of the parking lot.

As described above, the vehicle management device according to the present embodiment includes the management server 10 as an example of the vehicle management device in the vehicle management system that manages vehicles rentable between the users. The management server 10 includes a processing unit that processes the member information on the user of the vehicle management system, the member vehicle information on the vehicle owned or managed by the user, and the reservation management information on the reservation for use of the vehicle. The management server 10 includes a communication unit that can communicate with the rental vehicle 20A (vehicle 21) owned or managed by the owner member who desires to rent out a vehicle and the renter member vehicle 20B (vehicle 22) owned or managed by the renter member who desires to rent a vehicle. When the management server 10 receives the unlocking request notification from the rental vehicle, which indicates that the unlocking request based on the key information for allowing the renter member to temporarily use the rental vehicle has been received, the management server 10 checks the state of the renter member vehicle, determines that the unlocking condition is satisfied in a case where the renter member vehicle is under the management of the system, and transmits unlocking permission information for unlocking the electronic lock of the rental vehicle. Accordingly, in the case where the vehicle are rented between the users, the owner member can ensure the guarantee regarding the vehicle rental based on the state check of the vehicle of the renter member who desires to use a vehicle, and can rent out the host vehicle. In addition, the vehicle can be smoothly rented between the users without increasing the preparation, the procedure, and the like for ensuring the guarantee, and the convenience of the system can be improved.

The management server 10 acquires the position information of the renter member vehicle 20B (the vehicle 22), and determines that the renter member vehicle is under the management of the system according to at least one of a state in which the renter member vehicle is in the parking state at a predetermined place, a state in which the renter member vehicle is rentable to another user, and a state in which the renter member vehicle is being rented to the other user. Accordingly, it is possible to determine whether the vehicle of the renter member is under the management of the system by a simple method without providing a complicated configuration or procedure.

The management server 10 can communicate with the owner member terminal (terminal 31) used by the owner member and the renter member terminal (terminal 32) used by the renter member. The management server 10 acquires the rent-out application information including the rental period and the rental place where the owner member can rent out a vehicle and the member vehicle information of the owner member, and acquires the use application information including the use period and the use place desired by the renter member and the member vehicle information of the renter member. The management server 10 extracts a matched one from the rent-out application information for the reservation request including the use application information, inquires of the owner member terminal of the corresponding owner member about the rental permission, and receives the rental approval. The management server 10 determines that the reservation regarding the reservation request is confirmed in response to the rental approval, and transmits the key information corresponding to the confirmed reservation information to the renter member terminal from which the reservation request is received. Accordingly, the owner member suitable for the use period and the use place desired by the renter member can be extracted, and the reservation corresponding to the reservation request can be appropriately confirmed based on the rental approval of the owner member.

The management server 10 receives the reservation request from the renter member terminal (terminal 32), performs the matching processing between the use application information included in the reservation request and the stored rent-out application information, and inquires, about the lending permission, of the owner member terminal (terminal 31) of the owner member corresponding to the rent-out application information matching the reservation request. The management server 10 determines that the reservation regarding the reservation request is confirmed in response to the rental approval from the owner member terminal. Accordingly, the matching processing between the use application information and the rent-out application information can be performed to search for the rental vehicle suitable for the content of the reservation request, and the confirmation of the reservation can be appropriately determined by the rental approval of the owner member.

In a case where it is determined that the reservation is confirmed, the management server 10 issues the key information corresponding to the reservation request. Alternatively, in the case where it is determined that the reservation is confirmed, the management server 10 transmits an instruction to issue the key information corresponding to the reservation request to the rental vehicle 20A (vehicle 21) or the owner member terminal (terminal 31), and causes the rental vehicle 20A (vehicle 21) or the owner member terminal (terminal 31) to issue the key information. Accordingly, it is possible to appropriately issue the key information according to the reservation number or the like corresponding to the reservation request in accordance with the confirmation of the reservation, and to notify the renter member terminal (terminal 32) of the key information.

The key information is at least one of the reservation number corresponding to the reservation content for which the reservation has been confirmed, and an electronic key information or a two-dimensional code having authentication information including the reservation number. Accordingly, it is possible to rent the vehicle using the key information with high convenience for the user.

In accordance with the vehicle value information indicating the asset value of the vehicle included in the member vehicle information, the management server 10 sets the vehicle type that can be used by the renter member, and determines the rental vehicle that matches the reservation request. For example, in a case where the asset value of the vehicle of the renter member is high, the convenience of the renter member can be improved by, for example, enlarging a range of the selectable vehicle type and extending the use period. In addition, in a case where the asset value of the vehicle of the renter member is low, a rental risk of the owner member can be reduced by, for example, limiting the range of the selectable vehicle type and shortening the use period. As a result, in accordance with either one of the asset value of the vehicle owned or managed by the renter member and the asset value of the vehicle owned or managed by the owner member, or the asset values of the both, the vehicle type and the use period that can be appropriately used can be set, and reasonable rental and use of the vehicle according to the asset value can be made between the users.

In accordance with the reliability of the renter member included in the member information, the management server 10 sets the vehicle type and the use period that can be used by the renter member, and determines the rental vehicle that matches the reservation request. For example, in a case where the reliability of the renter member is high, the convenience of the renter member can be improved by, for example, enlarging the range of the selectable vehicle type and extending the use period. In addition, in a case where the reliability of the renter member is low, the rental risk of the owner member can be reduced by, for example, limiting the range of the selectable vehicle type and shortening the use period. Accordingly, in accordance with the reliability of the renter member, the vehicle type and the use period that can be appropriately used can be set, and the reasonable rental and use of the vehicle according to the reliability can be made between the users.

The management server 10 stores history information including various histories in past use by the renter member, and the history information includes at least one of the use period, the traveling history at the time of use, the accident history during the use period, the repair history, and the reliability based on an evaluation from the other user. Accordingly, it is possible to appropriately determine whether the rental approval is possible in the owner member in accordance with the past use history, the reliability, and the like of the renter member using the history information.

A vehicle management method according to the present embodiment is a vehicle management method in a vehicle management device of a vehicle management system that manages a vehicle rentable between users. The vehicle management method includes a step of communicating with the rental vehicle 20A (vehicle 21) and the renter member vehicle 20B (vehicle 22) in the management server 10 as the vehicle management device of the vehicle management system. In addition, when the management server 10 receives the unlocking request notification from the rental vehicle 20A (vehicle 21), which indicates that the unlocking request based on the key information for allowing the renter member to temporarily use the rental vehicle has been received, the management server 10 checks the state of the renter member vehicle 20B (vehicle 22), and in the case where the renter member vehicle is under the management of the system, determines that the unlocking condition is satisfied, and transmits the unlocking permission information for unlocking the electronic lock of the rental vehicle.

In the rental vehicle 20A, the electronic lock of the vehicle is unlocked based on the key information. Accordingly, in the case where the vehicle rented between the users, the owner member can ensure the guarantee regarding the vehicle rental based on the state check of the vehicle of the renter member who desires to use a vehicle, and can rent out the host vehicle.

A vehicle according to the present embodiment is a vehicle that can be used in a vehicle management system that manages a vehicle rentable between users. The rental vehicle 20A (vehicle 21) includes a vehicle communication unit that performs communication with the management server 10 as a vehicle management device that manages the vehicle management system, a key information processing unit that processes key information for allowing the renter member who desires to rent the host vehicle to temporarily use the host vehicle as the rental vehicle, and an unlocking processing unit that unlocks an electronic lock of the host vehicle based on the key information. In a case where the rental vehicle receives the unlocking request based on the key information, the management server 10 checks the state of the renter member vehicle 20B (vehicle 22) owned or managed by the renter member, and in the case where the renter member vehicle is under the management of the system, determines that the unlocking condition is satisfied, and unlocks the electronic lock. Accordingly, in the case where the vehicle is rented between the users, the owner member can ensure the guarantee regarding the vehicle rental based on the state check of the vehicle of the renter member who desires to use a vehicle, and can rent out the host vehicle.

Although various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. In addition, the constituent elements in the various embodiments described above may be optionally combined without departing from the gist of the present invention.

The present application is based on a Japanese Patent Application (Japanese Patent Application No. 2019-068807) filed on Mar. 29, 2019, and the contents thereof are incorporated herein by reference.

The present disclosure is useful as a vehicle management device, a vehicle management method, and a vehicle in a vehicle management system in which further improvement can be realized in the case where a vehicle is rented between users of car sharing.

1. A vehicle management device in a vehicle management system configured to manage a vehicle rentable between users, the vehicle management device being configured to process member information on a user of the vehicle management system, member vehicle information on a vehicle owned or managed by the user, and reservation management information on reservation of use of the vehicle, the vehicle management device comprising:
a communication device configured to communicate with a rental vehicle owned or managed by an owner member who desires to rent out a vehicle and a renter member vehicle owned or managed by a renter member who desires to rent a vehicle;
a processor; and
a memory having instructions that, when executed by the processor, cause the vehicle management device to perform operations comprising:
checking a state of the renter member vehicle in response to receipt of an unlocking request notification from the rental vehicle through the communication device, the unlocking request notification indicating receipt of an unlocking request based on key information for allowing the renter member to temporarily use the rental vehicle;
determining that an unlocking condition is satisfied in a case where the renter member vehicle is under management of the vehicle management system; and
transmitting unlocking permission information for unlocking an electronic lock of the rental vehicle through the communication device in a case where the unlocking condition is determined to be satisfied.

2. The vehicle management device according to claim 1,
wherein the checking the state of the renter member vehicle comprises:
acquiring position information of the renter member vehicle; and
determining that the renter member vehicle is under management of the vehicle management system according to at least one of a state in which the renter member vehicle is in a parking state at a predetermined place, a state in which the renter member vehicle is rentable to another user, and a state in which the renter member vehicle is being rented to another user.

3. The vehicle management device according to claim 1,
wherein the communication device is configured to communicate with an owner member terminal used by the owner member and a renter member terminal used by the renter member, and
wherein the operations further comprise:
acquiring rent-out application information comprising a rental period and a rental place where the owner member is able to rent out a vehicle and member vehicle information of the owner member;
acquiring use application information comprising a use period and a use place desired by the renter member and member vehicle information of the renter member;
extracting a piece of the rent-out application information from the rent-out application information which matches a reservation request comprising the use application information;
transmitting a rental permission inquiry to the owner member terminal of the owner member corresponding to the piece of the rent-out application information about rental permission through the communication device;
determining that a reservation regarding the reservation request is confirmed in response to a rental approval transmitted from the owner member terminal in response to the rental permission inquiry and received through the communication device; and
transmitting key information corresponding to confirmed reservation information to the renter member terminal from which the reservation request is received through the communication device.

4. The vehicle management device according to claim 3,
wherein the extracting the piece of the rent-out application information comprises performing matching processing between the use application information contained in the reservation request and the rent-out application information according to the reservation request received from the renter member terminal through the communication device.

5. The vehicle management device according to claim 3,
wherein the operations further comprise issuing key information corresponding to the reservation request or transmitting an instruction to issue key information corresponding to the reservation request to the rental vehicle or the owner member terminal through the communication device in a case where it is determined that the reservation is confirmed.

6. The vehicle management device according to claim 5,
wherein the key information comprises at least one of a reservation number corresponding to a reservation content for which the reservation has been confirmed, and an electronic key information or a two-dimensional code having authentication information comprising the reservation number.

7. The vehicle management device according to claim 3,
wherein the operations further comprise setting a vehicle type available to the renter member in accordance with vehicle value information indicating an asset value of the vehicle included in the member vehicle information, and
wherein the extracting the piece of the rent-out application information comprises determining a rental vehicle that matches the reservation request based on the vehicle type.

8. The vehicle management device according to claim 3,
wherein operations further comprise setting a vehicle type and a use period available to the renter member in accordance with reliability of the renter member contained in the member information, and
wherein the extracting the piece of the rent-out application information comprises determining a rental vehicle that matches the reservation request based on the vehicle type and the use period.

9. The vehicle management device according to claim 3,
wherein the memory stores history information comprising various histories in past use by the renter member, and
wherein the history information comprises at least one of a use period, a traveling history at a time of use, an accident history during a use period, a repair history, and reliability based on an evaluation from another user.

10. A vehicle management method in a vehicle management device of a vehicle management system that manages a vehicle rentable between users, the vehicle management device is configured to:
process member information on a user of the vehicle management system, member vehicle information on a vehicle owned or managed by the user, and reservation management information on reservation of use of the vehicle; and
communicate with a rental vehicle owned or managed by an owner member who desires to rent out a vehicle and a renter member vehicle owned or managed by a renter member who desires to rent a vehicle, the vehicle management method comprising:
checking a state of the renter member vehicle in response to receipt of an unlocking request notification from the rental vehicle, the unlocking request notification indicting receipt of an unlocking request based on key information for allowing the renter member to temporarily use the rental vehicle;
determining that an unlocking condition is satisfied in a case where the renter member vehicle is under management of the vehicle management system; and
transmitting unlocking permission information for unlocking an electronic lock of the rental vehicle in a case where the unlocking condition is determined to be satisfied.

11. The vehicle management method according to claim 10,
wherein the checking the state of the renter member vehicle comprises:
acquiring position information of the renter member vehicle; and
determining that the renter member vehicle is under management of the vehicle management system according to at least one of a state in which the renter member vehicle is in a parking state at a predetermined place, a state in which the renter member vehicle is rentable to another user, and a state in which the renter member vehicle is being rented to another user.

12. The vehicle management method according to claim 10,
wherein the vehicle management device is configured to communicate with an owner member terminal used by the owner member and a renter member terminal used by the renter member, and
wherein the vehicle management method further comprises:
acquiring rent-out application information comprising a rental period and a rental place where the owner member is able to rent out a vehicle and member vehicle information of the owner member;
acquiring use application information comprising a use period and a use place desired by the renter member and member vehicle information of the renter member;
extracting a piece of the rent-out application information from the rent-out application information which matches a reservation request comprising the use application information;
transmitting a rental permission inquiry to the owner member terminal of the owner member corresponding to the piece of the rent-out application information about rental permission;
determining that a reservation regarding the reservation request is confirmed in response to a rental approval transmitted from the owner member terminal in response to the rental permission inquiry; and
transmitting key information corresponding to confirmed reservation information to the renter member terminal from which the reservation request is received.

13. The vehicle management method according to claim 12,
wherein the extracting the piece of the rent-out application information comprises performing matching processing between the use application information contained in the reservation request and the rent-out application information according to the reservation request received from the renter member terminal.

14. The vehicle management method according to claim 12, further comprising:
issuing key information corresponding to the reservation request or transmitting an instruction to issue key information corresponding to the reservation request to the rental vehicle or the owner member terminal in a case where it is determined that the reservation is confirmed.

15. The vehicle management method according to claim 14,
wherein the key information comprises at least one of a reservation number corresponding to a reservation content for which the reservation has been confirmed, and an electronic key information or a two-dimensional code having authentication information comprising the reservation number.

16. The vehicle management method according to claim 12, further comprising:
setting a vehicle type available to the renter member in accordance with vehicle value information indicating an asset value of the vehicle included in the member vehicle information,
wherein the extracting the piece of the rent-out application information comprises determining a rental vehicle that matches the reservation request based on the vehicle type.

17. The vehicle management method according to claim 12, further comprising:
setting a vehicle type and a use period available to the renter member in accordance with reliability of the renter member contained in the member information,
wherein the extracting the piece of the rent-out application information comprises determining a rental vehicle that matches the reservation request based on the vehicle type and the use period.

18. The vehicle management method according to claim 12,
wherein the vehicle management device stores history information comprising various histories in past use by the renter member, and
wherein the history information comprises at least one of a use period, a traveling history at a time of use, an accident history during a use period, a repair history, and reliability based on an evaluation from another user.

19. A vehicle that is usable in a vehicle management system that manages a vehicle rentable between users, the vehicle comprising:
a vehicle communication device configured to communicate with a vehicle management device configured to manage the vehicle management system;
a processor; and
a memory having instructions that, when executed by the processor, cause the vehicle to perform operations comprising:
transmitting an inquiry to the vehicle management device about a state of a renter member vehicle owned or managed by a renter member in response to receipt of an unlocking request based on key information for allowing the renter member who desires to a host vehicle to temporarily use the host vehicle as a rental vehicle;
determining that an unlocking condition is satisfied in a case where the renter member vehicle is under management of the vehicle management system based on a response to the inquiry transmitted from the vehicle management device and received through the vehicle communication device; and
unlocking an electronic lock of the host vehicle based the key information in a case where the unlocking condition is determined to be satisfied.

20. The vehicle according to claim 19,
wherein the unlocking condition is determined to be satisfied in a case where unlocking permission information is received as the response from the vehicle management device.
